(19) United States
(12) Patent Application Publication
(10) Pub. No.: US 2007/0194936 A1
(43) Pub. Date: Aug. 23, 2007

(54) Contactless communication scheme and contactless communication system

(75) Inventor: Masaki Hoshina, Suwa-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 11/702,362

(22) Filed: Feb. 5, 2007

(30) Foreign Application Priority Data
Feb. 14, 2006 (JP) 2006-036107

(51) Int. Cl. G08B 13/14; H04Q 5/22

(52) U.S. Cl. 340/572.8; 340/10.51

(57) ABSTRACT

A contactless communication scheme includes: a first and a second RFID tags that are each registered with a unique ID and communicate in a contactless manner by making use of an electromagnetic field of an antenna; and a reader/writer that reads/writes data in a contactless manner with respect to the first and the second RFID tags, wherein the first RFID tag generates power from the electromagnetic field produced by the reader/writer and makes use of the power to communicate with the second RFID tag.

### BACKGROUND OF THE INVENTION

1. Technical Field

The present invention relates to a contactless communication scheme and a contactless communication system.

2. Related Art

Conventional Radio Frequency Identification (RFID) tags are mainly aimed at reading of the IDs of RFID tags and reading/writing of history and/or other data. Some are provided with a sensor part having a temperature sensor, wherein the temperature measured by the temperature sensor is written into the EEPROM once in every predetermined time period by the CPU of the sensor part, and the temperature data written into the EEPROM are read by an external reader/writer.

JP-A-2001-187611 is an example of related art.

However, adding a new function such as a sensor function to an existing RFID tag presents a challenge in terms of the hardware configuration, so that it is required that either a new RFID tag having the necessary functions is substituted for the existing one or all necessary functions are mounted in advance to an RFID tag. This has lead to an increase in the cost of the entire system.

### SUMMARY

An advantage of the present invention is to provide a contactless communication scheme and a contactless communication system that efficiently add new functions to RFID tags.

A contactless communication scheme according to a first aspect of the invention includes; a first and a second RFID tags each of which is assigned to a unique ID and communicate in a contactless manner utilizing the electromagnetic field of an antenna; and a reader/writer that reads/writes data in a contactless manner with respect to the first and the second RFID tags. The first RFID tag generates power from the electromagnetic field produced by the reader/writer and utilizes the power to communicate with the second RFID tag. By using inter-RFID-tag communication that makes use of load modulating signals of RFID tags, the aspect allows RFID tags to appear as if new functions had been added to them, i.e. the aspect allows an RFID tag and another RFID tag to appear as if they had been integrated through use of the inter-RFID-tag communication. This allows an RFID tag to be added with new functions, without being provided with a plurality of functions in advance, thereby promising a reduction in the cost of RFID tags.

The contactless communication scheme may employ load modulation for communication between the first RFID tag and the second RFID tag. This allows the RFID tags to appear as if they had been added with new functions by using inter-RFID-tag communication that makes use of load modulating signals of RFID tags, i.e. as if they had been integrated by using the inter-RFID-tag communication.

A contactless communication system according to a second aspect of the invention includes: a first and a second RFID tags that are each registered with a unique ID and communicate in a contactless manner utilizing the electromagnetic field of an antenna; and a reader/writer that reads/writes data in a contactless manner with respect to the first and the second RFID tags. The first RFID tag generates power from the electromagnetic field produced by the reader/writer and uses the power to communicate with the second RFID tag, thereby causing the reader/writer to consider that the first RFID tag has been added with the functions of the second RFID tag. By using inter-RFID-tag communication, making use of load modulating signals of RFID tags, as a means to add new functions to RFID tags, the aspect allows RFID tags to appear as if new functions had been added to them, i.e. the aspect allows an RFID tag and another RFID tag to appear as if they had been integrated through use of the inter-RFID-tag communication. This allows RFID tags to be added with new functions, without being provided with a plurality of functions in advance, thereby promising a reduction in the cost of RFID tags.

The contactless communication system may employ load modulation for communication between the first RFID tag and the second RFID tag. This allows the RFID tags to appear as if they had been added with new functions through use of inter-RFID-tag communication that makes use of load modulating signals of RFID tags, as a way to add new functions to the RFID tags, i.e. as if they had been integrated through use of the inter-RFID-tag communication.

In the contactless communication system, the functions added to the RFID tags may be at least one of a nonvolatile display function, a sensor function and a memory function.

### BRIEF DESCRIPTION OF THE DRAWINGS

The invention will be described with reference to the accompanying drawings, wherein like numbers reference like elements.

FIG. 1 is a diagram showing a contactless communication system according to an embodiment of the invention.

FIG. 2 is a functional block diagram of a tag according to the embodiment of the invention.

FIG. 3 is a functional block diagram of a reader/writer according to the embodiment of the invention.

FIG. 4 is a diagram describing the addition of a tag in the contactless communication system according to the embodiment of the invention.

FIG. 5 is a flowchart diagram concerning acquisition of the UID and the functions of a tag according to another embodiment of the invention.

FIG. 6 is a diagram describing the association of tags on the database according to the embodiment of the invention.

FIG. 7 is a flowchart diagram concerning the transmission timing of a master-slave command to be transmitted to the reader/writer from the PC system according to the embodiment of the invention.

FIG. 8 is a flowchart diagram concerning the transmission timing of a reader/writer according to the embodiment of the invention.

FIG. 9 is a flowchart diagram concerning the transmission timing between tags according to the embodiment of the invention.

FIGS. 10A and 10B are diagrams describing an example of the structures of the send data according to the embodiment of the invention.

FIG. 11 is a diagram describing an example of the structures of the send data according to the embodiment of the invention.

FIGS. 12A, 12B and 12C are diagrams describing an example of the structures of the send data according to the embodiment of the invention.

FIGS. 13A and 13B are diagrams describing an example of the structures of the send data according to the embodiment of the invention.

### DESCRIPTION OF EXEMPLARY EMBODIMENTS

Exemplary embodiments of the invention will be described.

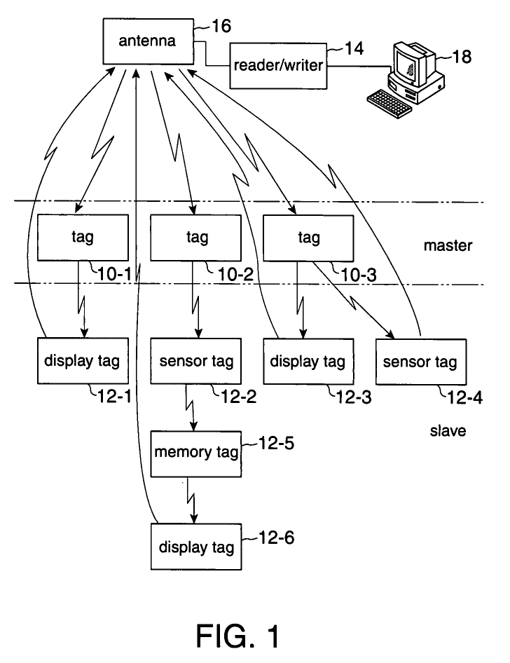

FIG. 1 is a diagram showing a contactless communication system according to one embodiment. The contactless communication system, as shown in FIG. 1, has (1) a plurality of RFID tags (hereinafter referred to simply as “tags”) that include master RFID tags (hereinafter referred to simply as “master tags”) 10-1 to 10-3 and slave RFID tags (hereinafter referred to simply as “slave tags”) 12-1 to 12-6, (2) a reader/writer 14, (3) an antenna 16 and (4) a PC system 18.

A contactless communication scheme according to a second embodiment of the invention makes use of the respective load modulating signals of the master tags 10-1 to 10-3 and the slave tags 12-1 to 12-6 using induced electromotive force from the reader/writer 14. For example, the scheme makes use of the load modulating signals for communication between the master tag 10-1 and the slave tag 12-1, between the master tag 10-2 and the slave tag 12-2, between the master tag 10-3 and the slave tag 12-3, and between the master tag 10-3 and the slave tag 12-4. In the same way, it makes use of the load modulating signals for communication between the slave tag 12-2 and the slave tag 12-5 and between the slave tag 12-5 and the slave tag 12-6. Further in the same way, the scheme makes use of the load modulating signals for communication between the slave tag 12-1 and the reader/writer 14, between the slave tag 12-6 and the reader/writer 14, between the slave tag 12-3 and the reader writer 14 and between the slave tag 12-4 and the reader/writer 14.

The tags that make use of the load modulating signals to communicate with each other are in a master-slave relationship. For example, the master tag 10-1, being master, utilizes the load modulating signals to communicate with the slave tag 12-1, being slave subordinate to the master.

In the past, the load modulating signals used for communication have been those signals that change parameters of the resonance circuit in a tag, thereby changing the size and/or the phase of the impedance of the tag, while the coil of an antenna electromagnetically couples the tag with a reader/writer through electromagnetic induction. The signals have been utilized in a contactless data transfer scheme in which the reader/writer detects changes in the impedance, thereby converting the changes into data transmitted from the tag, i.e. into data in the form of either 1 or 0 in accordance with the presence or absence of the data.

Since the load modulating signals have been modulated on the basis of the frequency during the electromagnetic coupling of the reader/writer and the tag (e.g. 13.56 MHz), they do not transfer data from the reader/writer and leave the tag in a situation where induced electromotive force has been generated in the tag. When load modulating signals are transmitted from one tag to another, the above situation allows this other tag to use the circuit for receiving data from the reader/writer to read changes in the load modulating signals transmitted from the one tag. Utilization of this circuit allows data transfer making use of load modulating signals to be carried out between tags without addition of a new circuit for receiving load modulating signals from another tag. In addition, the reader/writer 14 does not send any modulated data while tags are making use of load modulating signals for communication. The reader/writer 14 sends only those carriers having a predetermined frequency (e.g. 13.56 MHz) while tags are using load modulating signals for communication. The carriers are used only for generating power for the ICs in the master tags 10-1 to 10-3 and the slave tags 12-1 to 12-6 when those carriers are received by the master tags 10-1 to 10-3 and the slave tags 12-1 to 12-6.

The PC system 18 is provided with an operation part and a memory part (not illustrated). In the PC system 18, a tag to be master is selected and then a slave tag for adding functions to the master tag is selected. When it is desired to add a display function thereto, the slave tag 12-1, for example, that supports display among the mounted functions, is selected, and the data to be sent to the master tag 10-1 and the slave tag 12-1 are transferred to the reader/writer 14. Thus, the PC system 18 manages the route through which the functions of the master tag 10-1 and the slave tag 12-1, existing within the communication area of the reader/writer 14, have been logically added.

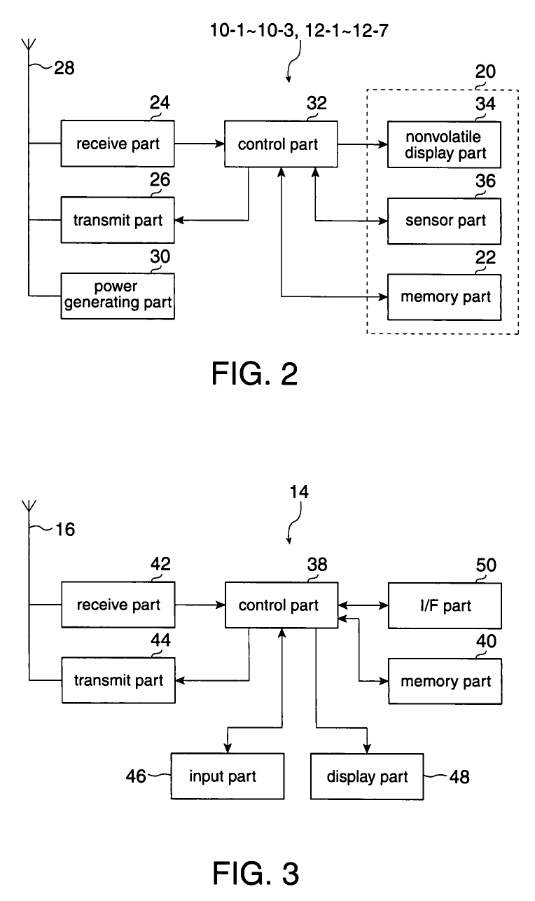

Referring to FIG. 2, an RFID tag according to the embodiment will be described.

As shown in FIG. 2, the master tags 10-1 to 10-3 each have a functional part 20 (memory part 22) representing a predetermined functional means, a receive part 24 and a transmit part 26 representing a communication means that is capable of contactless data communication with outside, an antenna 28, a power generating part 30 and a control part 32. The slave tags 12-1 to 12-6 each have a functional part 20 representing a predetermined functional means (at least one function of a nonvolatile display part 34, a sensor part 36 and a memory part 22), a receive part 24 and a transmit part 26 representing a communication means capable of wireless data communication with outside, an antenna 28, a power generating part 30 and a control part 32. The master tags 10-1 to 10-3 and the slave tags 12-1 to 12-6 each have transmit and receive functions.

The antenna 28 is composed of a resonance circuit in which an antenna coil and a resonant capacitor are connected in parallel. When signals modulated with 13.56 MHz, for example, are sent from the reader/writer 14 that represents both an external reading and writing means, an induced electromotive force is generated through electromagnetic coupling and the power is supplied to the power generating part 30.

The power generating part 30 is a component of the operational power supply circuit in the master tags 10-1 to 10-3 and the slave tags 12-1 to 12-6. It rectifies the electric wave signals for power generation transmitted from the antenna 28, smoothes them into direct-current electricity of a predetermined voltage (operational electricity) and supplies the electricity to the control and other parts.

The receive part 24 demodulates the data and other signals, which have been transmitted from the reader/writer 14 as well as from the master tags 10-1 to 10-3 and the slave tags 12-1 to 12-6 by being superimposed on the electric wave signals for power generation, and sends the data signals to the control part 32.

The transmit part 26, which performs the processing for sending data, functions as a data transmit part that transmits send data at a predetermined transmission timing. The transmit part 26 transfers send data to the resonance circuit, having been electromagnetically coupled, in accordance with the command from the control part 32. It can also be composed of a general-purpose logic device such as the Field Programmable Gate Array (FPGA) that allows users to alter the internal logic by a program after the IC has been completed. The transmit part 26 transmits data here with a predetermined frequency such as 13.56 MHz.

The control part 32 performs processing operations including generation of data to be transmitted, decisions on the transmission timing, control of the entire operation of the wireless transmitter, and so on. Its functions can be realized by various processors (CPUs, and the like), by hardware including ASICs (gate arrays, and the like) or by given programs (microprograms, and the like). The control part 32, which functions as a transmission timing deciding part that decides the transmission timing of data to be sent, creates the transmission timing and sends data. The transmission timing may be decided, for example, by software in using e.g. a housed timer, and the like, or by hardware that is a dedicated circuit. In addition, the control part 32 functions as a send data generating means that generates data to be sent. This may include, for example, cases where send data are created based on the data stored in the memory part 22, cases where they are created based on the data detected by the functional part 20 and cases where they are created based on the data operated in the control part 32.

The functional part 20 has at least one of a nonvolatile display part 34, a sensor part 36 and the memory part 22.

The nonvolatile display part 34 is for display of the display data transmitted from the reader/writer 14. For example, the master tags 10-1 to 10-3 and the slave tags 12-1 to 12-6 analyze received data in the control part 32 and execute processing of the received data in the slave tags 12-1, 12-3 and 12-6. If there are any data to be displayed as a result, the display data are fetched from the received data in accordance with the command of the control part 32, to be displayed via the display drivers of the slave tags 12-1, 12-3 and 12-6.

The sensor part 36, which is for detection of sensing data, can be realized by a thermistor, or the like, if temperature data are to be sent, and has a data detection/measurement function to detect data at a given time in accordance with the command from the control part 32. The data to be detected/measured are not limited to temperature data, but may also be humidity, barometric pressure, location, and such other data.

The memory part 22 includes a RAM that temporarily keeps data and a nonvolatile memory area. The RAM is to become a working area for the control part 32 (or the receive part 24, the transmit part 26, the nonvolatile display part 34 or the sensor part 36), and the like. The nonvolatile display part, which is a storage medium that stores the UID for identification of each of the master tags 10-1 to 10-3 and the slave tags 12-1 to 12-6, is composed of the EEPROM, a ROM, a FLASH, a FeRAM, and so on. In the present embodiment, those master tags 10-1 to 10-3 and slave tags 12-1 to 12-6 that are each adapted, for example, to transmit as send data only the unique ID (hereinafter referred to as “UID”) of themselves stored in the memory part 22, are also included. In such cases, the nonvolatile display part 34 and the sensor part 36 can be dispensable components. The data either measured or detected by the sensor at a given time may also be transmitted in the form of the measurement (detection) time+measured (detected) data. Furthermore, the measured data may be sent either as soon as the next transmission timing comes or en bloc after data from several measurements have been accumulated in the memory part 22.

The antenna 28, the power generating part 30, the receive part 24, the transmit part 26, the control part 32 and the functional part 20, having been thus composed as described above, are mounted on a flexible printed wiring board (not illustrated) to be integrated and molded with plastic and made into any of the master tags 10-1 to 10-3 and the slave tags 12-1 to 12-6. The flexible wiring board may be packaged by ink jet method using metal ink for wiring, in which case the IC chips of the contactless tags can also be packaged at the same time.

Referring to FIG. 3, the reader/writer 14 according to the embodiment, functioning as an external reading and writing means with respect to the above master tags 10-1 to 10-3 and slave tags 12-1 to 12-6, will be described. As shown in FIG. 3, the reader/writer 14 is connected with a control part 38 and a memory part 40 that stores operating and other programs as well as temporarily stores data, and the like. The control part 38 is connected with a receive part 42 and a transmit part 44 that in turn are in connection with the antenna 16. The control part 38 is connected with various input parts 46, with a display part 48 that displays contents including those inputted by the input parts 46 or those transmitted to or received from the master tags 10-1 to 10-3 and the slave tags 12-1 to 12-6, as well as with an I/F part 50 for transmission of data to the PC system 18, and the like.

When the control part 38, functioning as an integrated controller of the entire reader/writer 14, communicates with the master tags 10-1 to 10-3 and the slave tags 12-1 to 12-6, it first modulates carrier signals in the transmit part 44 and sends the modulated signals from the antenna 16 as electric wave signals for power generation. Subsequently, it causes the control parts 32 of the master tags 10-1 to 10-3 and the slave tags 12-1 to 12-6 to operate. Then, it modulates the data to be sent in the transmit part 44 in such a way that they are superimposed on the electric wave signals for power generation, and sends the modulated signals from the antenna 16 in the form of electric wave signals for power generation. The data that have been transmitted from the master tags 10-1 to 10-3 and the slave tags 12-1 to 12-6 as a response to the reader/writer data, are received by the antenna 16 and demodulated and discriminated as data in the receive part 42. The data discriminated in the receive part 42 are temporarily stored in the memory part 40 and then sent from the I/F part 50 to the PC system 18.

The contactless communication scheme according to the embodiment utilizes load modulating signals for communication between tags. The load modulating signals utilized in the communication is capable of responding only with a very small amount of power, because the response is caused by the induced electromotive force (power generated by electromagnetic induction) from the reader/writer 14. This is due to the fact that the master tags 10-1 to 10-3 and the slave tags 12-1 to 12-6 do not have embedded internal power (battery cells). Therefore, when a large amount of modulated data are sent from the reader/writer 14 while load modulating signals are utilized for communication between the master tags 10-1 to 10-3, the slave tags 12-1 to 12-6 and the reader/writer 14, the slave tags 12-1 to 12-6 and the reader/writer become incapable of accepting the receive data. While the master tags 10-1 to 10-3, the slave tags 12-1 to 12-6 and the reader/writer 14 are communicating with each other using load modulating signals, the reader/writer keeps on sending only carriers (unmodulated). This causes induced electromotive force to be generated in the master tags 10-1 to 10-3 and the slave tags 12-1 to 12-6, thereby ensuring the communication between the master tags 10-1 to 10-3, the slave tags 12-1 to 12-6 and the reader/writer 14.

Communication between the master tags 10-1 to 10-3, the slave tags 12-1 to 12-6 and the reader/writer 14 allows the master tags 10-1 to 10-3 to appear as if new functions had been added to each of them. Furthermore, communication between the tags takes place only in one direction. For example, while communication from the master tag 10-1 to the slave tag 12-1 is taking place, it is only one-way communication. While one side is communicating, the other side is not allowed to communicate at the same time.

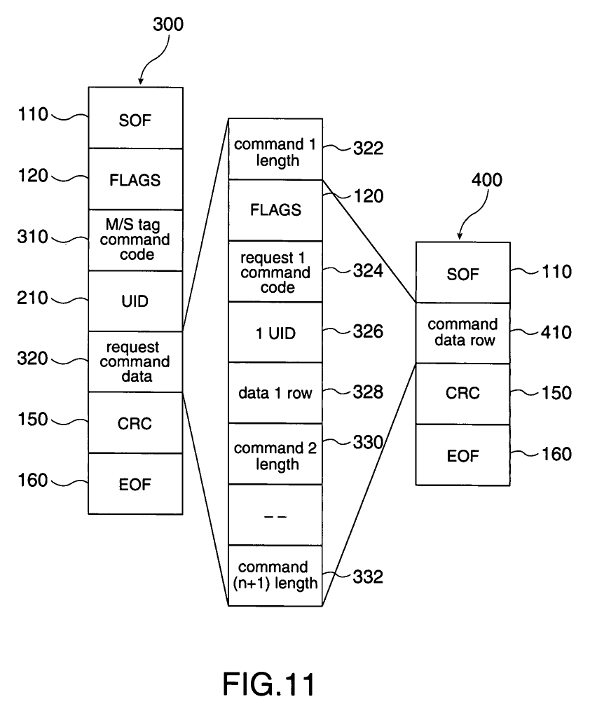

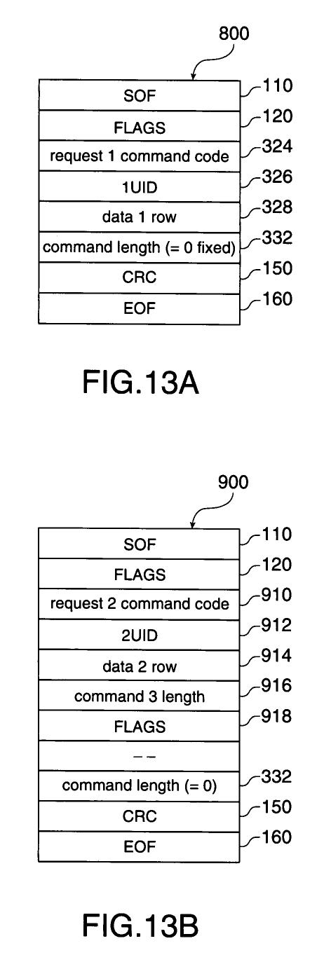

In cases where any command directed to a plurality of tags exists in the send data 300 (See FIG. 11) that are to be transmitted from the reader/writer 14 to the master tags 10-1 to 10-3, the send data 300 are divided in the master tags 10-1 to 10-3 to be made into send data 400 (See FIG. 11) directed to the next slave tags 12-1 to 12-4. Further, the send data 400 are divided in the slave tag 12-2 to be made into send data directed to the next slave tag 12-5. Still further, the send data are divided in the slave tag 12-5 to be made into send data directed to the next slave tag 12-6. For example, as shown in FIG. 1, the send data to be transmitted from the master tag 10-1 to the slave tag 12-1 are send data 800 (See FIG. 13A) to be transmitted to the one slave tag 12-1. Furthermore, the send data to be transmitted from the master tag 10-2 to the slave tag 12-2 are send data 900 (See FIG. 13B) to be transmitted to the slave tags 12-2, 12-5 and 12-6. The master tag 10-2 and the slave tags 12-2 and 12-5 add the obtained data in a bucket-brigade-like manner, finally to send them back to the reader/writer 14 through the slave tag 12-6.

Stated another way, the send data 900 in FIG. 13B are set with data directed to a plurality of slave tags 12-2, 12-5 and 12-6. The slave tag 12-2 validates if the next command (with a command length of not 0) exists in the send data 900 and if any such command exists, deletes the command directed to itself, sets the remaining data and adds the obtained data in a bucket-brigade-like manner to transmit to the slave tag 12-5. The slave tag 12-5 validates if the next command (with a command length of not 0) exists in the send data and if there is any such command, deletes the command directed to itself, sets the remaining data and adds the obtained data in a bucket-brigade-like manner to transmit to the slave tag 12-6. The slave tag 12-6 validates if the next command (with a command length of not 0) exists in the send data, adds the obtained data in a bucket-brigade-like manner to send them back to the reader/writer 14. In addition, the send data 800 in the communication between the master tag 10-1 and the slave tag 12-1, the master tag 10-3 and the slave tag 12-3, the master tag 10-3 and the master tag 12-4 and the slave tag 12-2 and the slave tag 12-5 are send data directed to one tag.

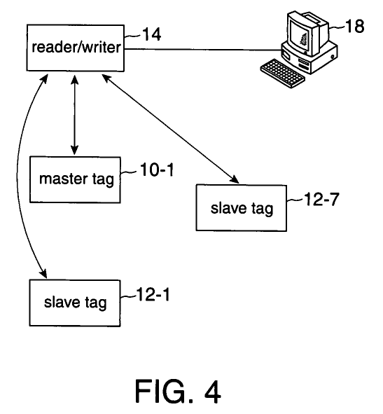

Referring to FIG. 4, the addition of a tag in the contactless communication system according to the first embodiment will be described. As shown in FIG. 4, when a slave tag 12-7 is newly added into the environment of the existing master tag 10-1 and slave tag 12-1, the PC system 18, knowing the UIDs of all existing tags, transmits and sets a command that causes none of the existing tags to respond to the reader/writer 14 and then search for tags (the antenna 16 is omitted). This causes only the new slave tag 12-7 to respond. As the response data include functions of the slave tag 12-7, the functions included in the tag that responded become apparent. The data responding to the reader/writer 14 are then transferred to the PC system 18 in which the information on the UID and the functions of the newly added master/slave tag is added and the information on the master/slave tags to which the reader/writer 14 can communicate is updated. The contactless communication scheme that allows communication between tags in utilizing load modulating signals of the tags, is applied to adding at least one of the functions of nonvolatile display, sensor and storage. For example, in cases where the slave tag 12-7 has the nonvolatile display part 34 as a nonvolatile display function, the slave tag 12-7 can receive display data from the master tag 10-1 and display the received data, if the master tag 10-1 utilizes load modulating signals to communicate with the slave tag 12-7 by inter-tag communication. This allows the master tag 10-1 to appear as if it had the functions of the slave tag 12-7. Further, in cases where the slave tag 12-7 has a sensor (temperature sensor) as a sensor function, the slave tag 12-7 receives the instruction to measure from the master tag 10-1 when the master tag 10-1 communicates with the slave tag 12-7. The slave tag 12-7 transmits to the reader/writer 14 the temperature or other sensing data that have been obtained from the measurement performed in accordance with the instruction. This allows the master tag 10-1 to appear as if it had the functions of the slave tag 12-7. The above description has been based on the assumption that the slave tag 12-7 exists from the start within the communication area that allows communication between the tags and the reader/writer 14, but the tag 12-7 may be additionally installed within the communication area of the reader/writer 14.

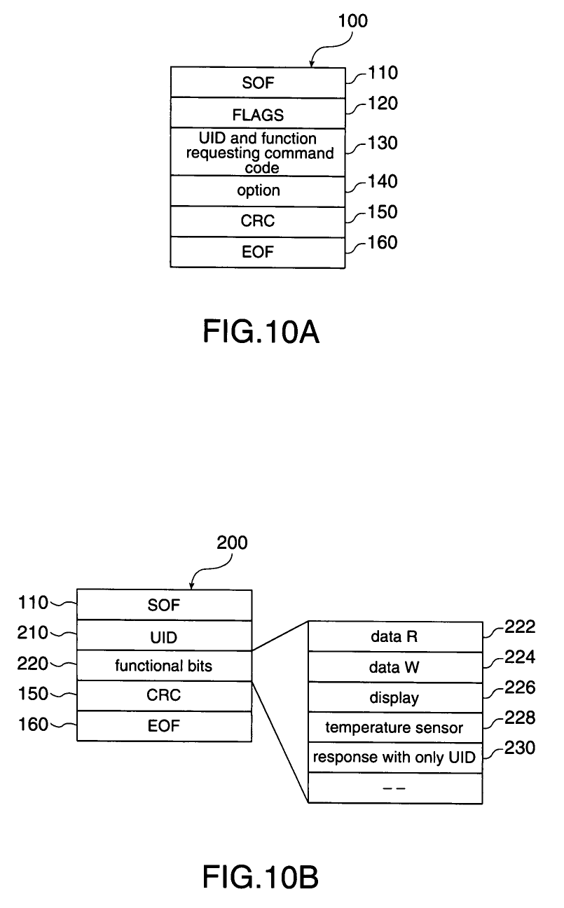

As shown in FIGS. 10A and 10B, FIGS. 12A, 12B and 12C, and FIGS. 13A and 13B, the communication data between the reader/writer 14 and the master tag 10-1 as well as the slave tag 12-1 are performed by the frame format that conforms to ISO/IEC 18000-3 or ISO/IEC15693, provided, however, that the frame format can also be configured otherwise, without being restricted to the above. The frame is configured with a format enclosed by Start of Field (SOF) and End of Field (EOF). In the CRC, results from the computation performed regarding the area in between the SOF and the CRC (i.e. from after the SOF through to before the CRC), pursuant to the provisions of ISO/IEC13239, are set. The frame is comprised of two types including a request frame transmitted from the reader/writer 14 and a response frame for the master tag 10-1 and the slave tag 12-1, having received the request frame, to answer the reader/writer. The request frame and the response frame are associated with the command code of the request frame, and communicate by commands that the command code defines.

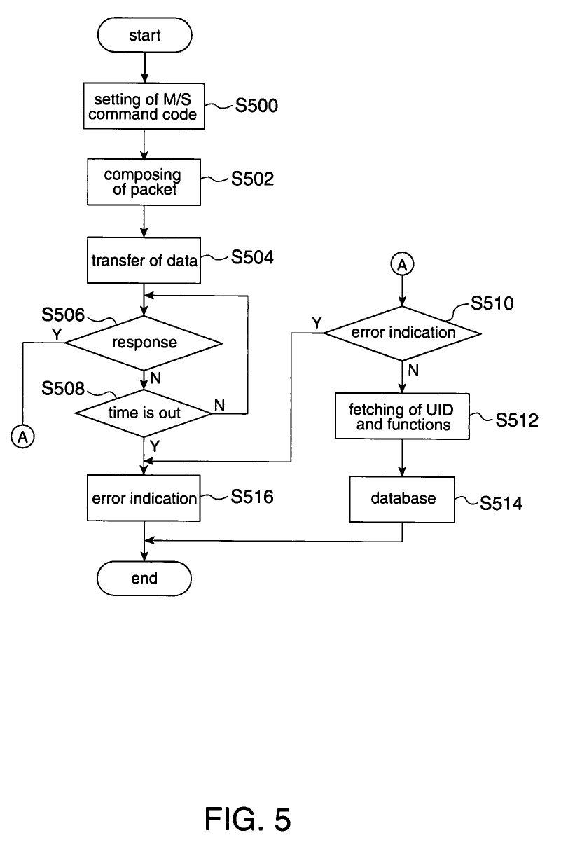

Referring to FIG. 5, the UIDs of the tags according to the present embodiment and the obtainment of the functions of the tags will be described. Regarding the contactless communication system, the configuration shown in FIG. 4 will be referenced hereinafter.

The reader/writer 14 obtains the UIDs of the master tag 10-1 and the slave tag 12-1 that exist within its own communication area. It obtains, at the same time, information as to what kinds of functions are loaded in the master tag 10-1 and the slave tag 12-1.

The reader/writer 14 transfers the UIDs and the loaded functions of the master tag 10-1 and the slave tag 12-1 to the PC system 18 connected to it.

In the PC system 18, the master tag 10-1 is selected to be mater, and then the slave tag 12-1 is selected for adding functions to the master tag 10-1. For example, if it is desired that the display function is added, the slave tag 12-1 supporting display is selected from among the loaded functions, and the data to be transmitted to the master tag 10-1 and the slave tag 12-1 are transferred to the reader/writer 14. Here, instead of using the slave tag 12-1 that is already installed within the communication area of the reader/writer 14, the slave tag 12-7 to be slave loaded with the new functions, may be newly added into the communication area. In this case, the UID and the functional information of the newly added slave tag 12-7 may be obtained either in advance or according to the method for obtaining the UID of a new tag in following the command from the reader/writer 14. First, as shown in FIG. 5, a master/slave command code is set (the step S500), for example “2FH.” A command code requesting the UIDs and the functions of the master tag 10-1 and the slave tag 12-1, which are capable of communicating with the reader/writer 14, may be set as well.

Then, send data 100 (See FIG. 10A) are composed (S502).

Then, the send data 100 are transferred to the reader/writer 14 (S504).

Then, a judgment is made as to whether or not the reader/writer 14 responds (S506). If it does not respond, the step S508 is taken. Then, a judgment is made as to whether time is out or not (S508). If time is not yet out, the step S506 is taken again. Then, error indication is made (S516), subsequently to terminate.

Then, a judgment is made as to whether to make an error indication or not (S510). If it is to be made, the step S516 is further taken, subsequently to terminate.

Then, the UIDs and the functions are fetched from the send data 100 (S512).

Then, they are set in the database of the PC system 18 (S514), subsequently to terminate.

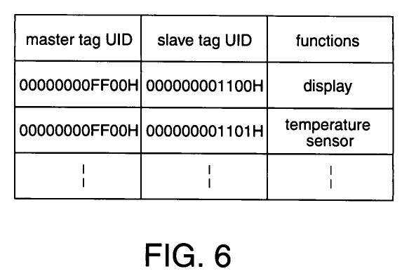

Referring to FIG. 6, association of the master/slave tags according to the embodiment, on the database, will be described. For example, a slave tag having the display function is associated on the database with a master tag.

First, a master tag supporting only UIDs is selected as a master tag.

Then, a slave tag having the display function is selected from the database.

Then, the slave tag is associated with the master tag that has been selected before.

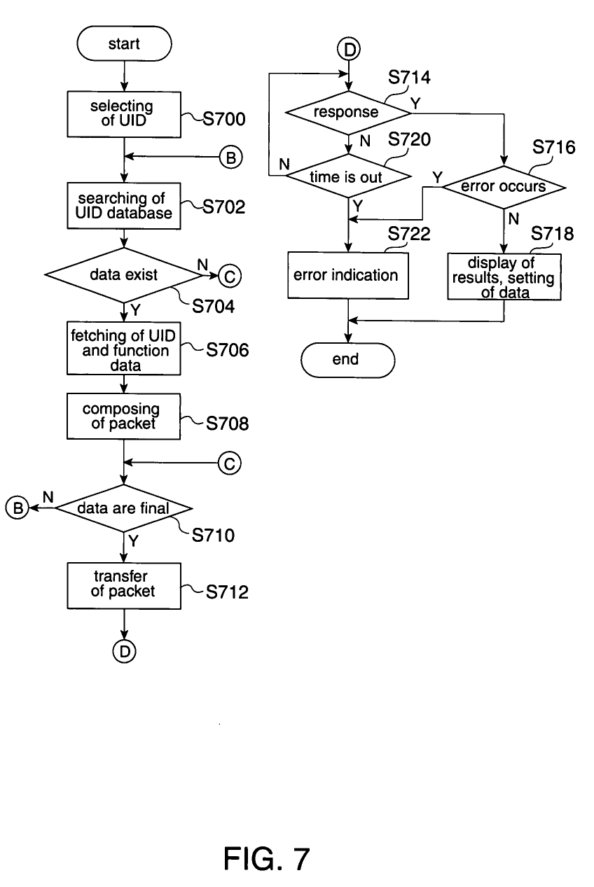

FIG. 7 is a flowchart diagram concerning the transmission timing for the master/slave command to be transmitted from the PC system to the reader/writer. The transmission timing for the master/slave command will be described.

First, the UID of the master tag 10-1 is selected (S700). One UID is selected for the master tag 10-1 from the association table in FIG. 6.

Then, the UID database of the master tag 10-1 is searched (S702).

Then, a judgment is made as to whether or not there are any data there (S704). If there are no data, the step S710 is further taken.

Then, the UID and the functional data of the slave tag 12-1 are fetched (S706).

Then, the send data 300 (See FIG. 11) directed to the reader/writer 14 are composed (S708).

Then, a judgment is made as to whether or not the data are final (S710). If they are not the last ones, the step S702 is taken again.

Then, the composed send data 300 are transferred to the reader/writer 14 (S712).

Then, a judgment is made as to whether or not the reader/writer 14 responds (S714). If it responds, the step S716 is further taken. If it does not respond, the step 720 is further taken. Then, a judgment is made as to whether or not the time is out (S720). If the time is not out, the step S714 is taken again. Then, an error indication is made (S722), subsequently to terminate.

Then, a judgment is made as to whether or not any errors have occurred (S716). If no error has occurred, the step S718 is further taken. If any error has occurred, the step 722 is further taken, subsequently to terminate.

Then, the results from the command processing are displayed and the information on the response data is set into the database (S718), subsequently to terminate. The data-setting may be done when there are any data, and the like, regarding the master tag 10-1 and the slave tag 12-1. There may be cases where only results are displayed.

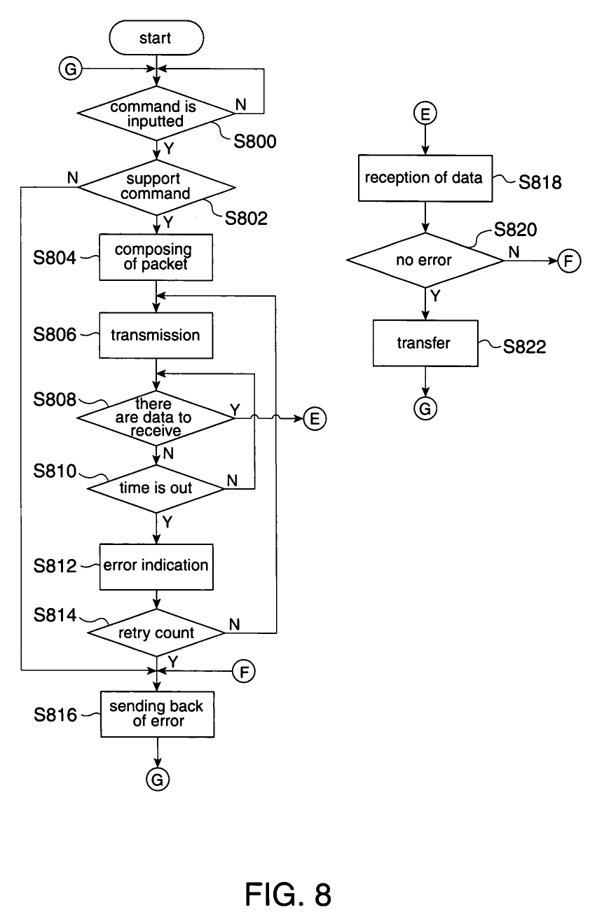

Referring to FIG. 8, the transmission timing of the reader/writer according to the embodiment will be described.

First, a judgment is made as to whether or not a command is inputted from the PC system 18 (S800). If no command is inputted, the step S800 is taken again.

Then, a judgment is made as to whether or not the inputted command is a support command (S802). If it is not a support command, the step S816 is further taken.

Then, the send data 300 are composed (S804).

Then, the send data 300 are transmitted to the master tag 10-1 (S806)

Then, a judgment is made as to whether to receive data from the tag or not (S808). If data are to be received from the tag, the step S818 is further taken. If data are not to be received, the step S810 is further taken. Then, a judgment is made as to whether the time is out or not (S810). If the time is not out, the step S808 is taken again. Then, if the time is out, error indication is made (S812). Then, a judgment is made as to whether or not the retry count is a prescribed count (S814). If it is not the prescribed count, the step S806 is taken again and the same command is transmitted again. If it is the prescribed count, the step S816 is further taken. Then, the PC error is sent back (S816). Then, the step S800 is taken again.

Then data are received from the tag (S818).

Then, a judgment is made as to whether or not there is any error (S820). If there is any error, the step S816 is further taken. If there is no error, the step S822 is further taken.

Then, the receive data is transferred to the PC system 18 (S822). Subsequently, the step S800 is taken again.

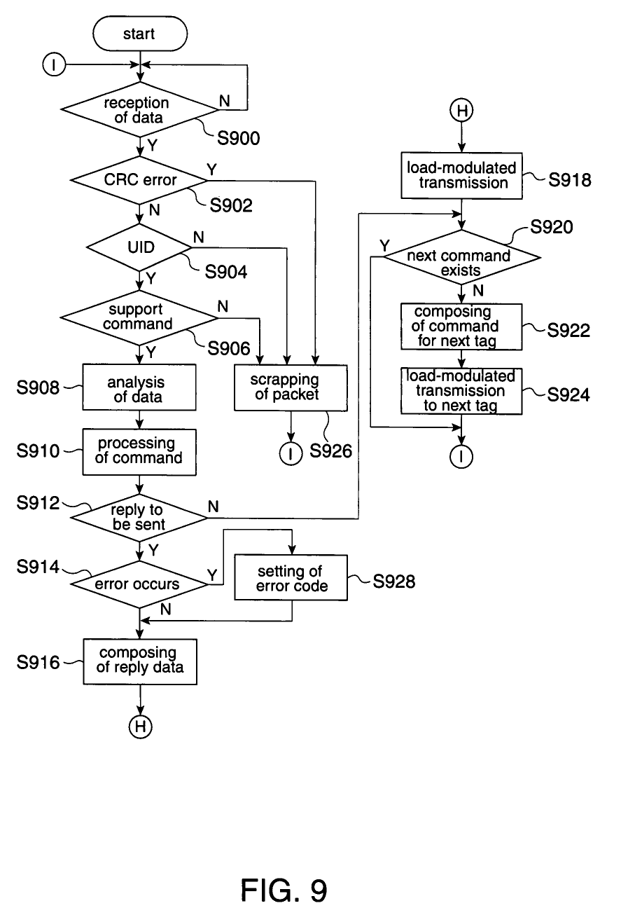

FIG. 9 is a flowchart diagram concerning the transmission timing between the tags according to the embodiment. The transmission timing for the master tag 10-1 and the slave tag 12-1 will be described.

The selection of the route of send data, as to whether it is from the master tag 10-1 to the slave tag 12-1 or from the master tag 10-2 to the slave tag 12-2 to the slave tag 12-5, depends on the structure (frame format) of the send data transmitted from the PC system 18.

The master tag 10-1, upon receiving data directed to itself from the reader/writer 14 via the antenna 16, analyzes the data with the control part 32. At this time, the master tag 10-1 restructures the data to be transmitted to the slave tag 12-1 and communicates with the slave tag 12-1 through inter-tag communication using load modulating signals. The slave tag 12-1, upon confirming that the data is directed to itself, fetches the data into its memory part 22, analyzes the received data and executes processing within itself For example, when any data is to be displayed, the slave tag 12-1 fetches the display data from the received data and transfers the display data via its display driver.

The slave tag 12-1, after it has received the data directed to itself and executed processing with respect to the designated functions, checks the data that it has received from the master tag 10-1 once again. As it has confirmed that no command is included for any slave tag other than itself, the slave tag 12-1 transmits response data to the reader/writer 14 and terminates. If any command is further included for any slave tag other than itself, the slave tag 12-1 communicates between tags after it has restructured the data, utilizing load modulating signals.

First, a judgment is made as to whether or not data have been received, and if they have not been received, the step S900 is taken again (S900).

Then, a judgment is made as to whether or not the received data are a CRC error (S902). If they are a CRC error, the step S926 is further taken. In the step S926, the send data are scrapped and, subsequently, the step S900 is taken again.

Then, a judgment is made as to whether or not the received data are a UID directed to the tag 10-1 itself (S904). If the UID is not directed to the tag 10-1 itself, the step S926 is further taken. In the step S926, the send data are scrapped and, subsequently, the step S900 is taken again.

Then, a judgment is made as to whether or not the received data are a support command (S906). If they are not a support command, the step S926 is further taken. In the step S926, the send data are scrapped and, subsequently, the step S900 is taken again.

Then, the command data of the received data are analyzed (S908).

Then, the command data of the received data are processed (S910).

Then, a judgment is made as to whether not a response should be made to the reader/writer 14 (S912). If a response should be made to the reader/writer 14, the step S914 is further taken. In the step S914, a judgment is made as to whether or not an error has occurred. If any error has occurred, the step S928 is further taken for the error code to be set.

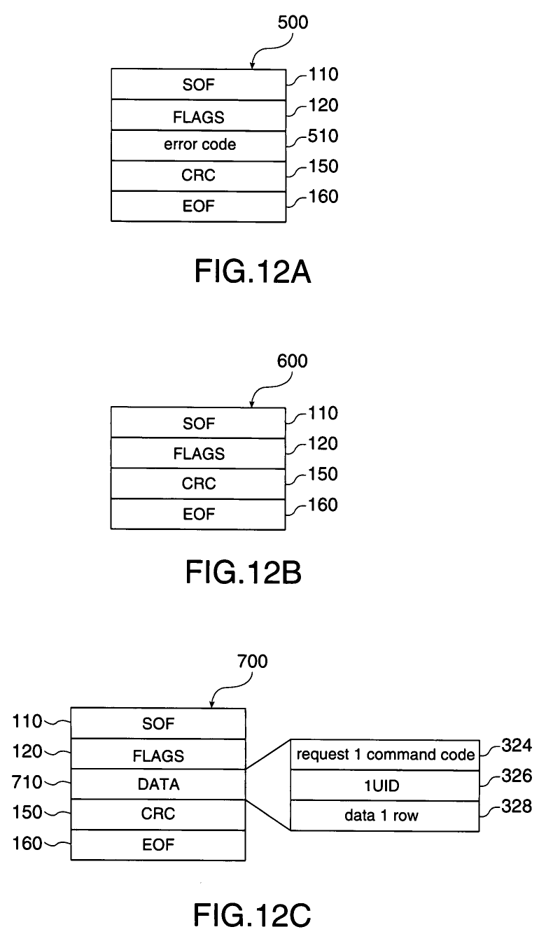

Then, the reply data are composed (S916). Any one of the send data 500 in FIG. 12A, the send data 600 in FIG. 12B and the send data 700 in FIG. 12C are used.

Then, a communication is made to the reader/writer 14 in utilizing load modulating signals (S918).

Then, a judgment is made as to whether or not the next command is 0, and if the next command is 0, the step S900 is taken again (S920), thereby corresponding with transmission from the master tag 10-1 to the slave tag 12-1.

Then, a command directed to the next slave tag 12-1 is composed (S922). The command is set after any part of the send data already executed by the master tag 10-1 itself has been deleted

Then, a communication is made to the next slave tag 12-1 in utilizing load modulating signals (S924).

FIGS. 10 (A, B) to 13 (A, B) are diagrams for describing an example (conforming to ISO-15963) of the structure of the send data according to the embodiment. Structures of the data sent by the reader/writer and the tags according to the embodiment will be described.

FIG. 10A is an example of the structure of send data 100 (request frame) in the case where a request is made from the reader/writer 14 to the tags 10-1, 12-1 and 12-7 regarding their IDs and functions. The send data 100 include the SOF 110, the FLAGS 120, the request command code for UID and functions 130, options 140, the CRC 150 and the EOF 160.

FIG. 10B is an example of the structure of send data 200 (response frame) in the case where a response is made from the master tag 10-1 and the slave tags 12-1, 12-7 to the reader/writer 14. The send data 200 include the SOF 110, the UID 210, functional bits 220, the CRC 150 and the EOF 160. The functional bits 220 include data R 222, data W 224, display 226, temperature sensor 228 and reply with only UID 230. The send data 200 are response information for the send data 100. Where the master tag 10-1 and the slave tags 12-1, 12-7 are supporting the functions, the data R 222, the data W 224, the display 226, the temperature sensor 228 and the reply with only UID 230 of the functional bits 220 are each set with 1.

FIG. 11 is an example of the structure of send data 300 (request frame) in the case where transmission is made from the reader/writer 14 to the master tag 10-1. The send data 300 include the SOF 110, the FLAGS 120, M/S tag command code 310, the UID 210, request command data 320, the CRC 150 and the EOF 160. The request command data 320 include command 1 length 322, the FLAGS 120, the request 1 command code 324, 1 UID 326, data 1 row 328, command 2 length 330 . . . and command (n+1) length 332. A normal request command code is included in the request command data 320, if the command is directed to the master tag 10-1 alone.

FIG. 11 is an example of the structure of send data 400 in the case where transmission is made from the master tag 10-1 to the slave tag 12-1. The send data 400 include the SOF 110, command data row 410, the CRC 150 and the EOF 160. The command data row 410 include the FLAGS 120, the request 1 command code 324, the 1 UID 326, the data 1 row 328, the command 2 length 330, . . . and the command (n+1) length 332. The slave tag 12-1, having received a transmission, executes the commands that are directed to itself. It examines the received command length (the next command length, which is the command 2 length 330 here) and if the length is 0, the slave tag 12-1 transmits to the reader/writer 14 any one of the send data 500, 600 and 700 in FIGS. 12A, 12B and 12C and terminates. If the length is not 0, the slave tag 12-1 makes the send data 400 in FIG. 11 and communicates to the next slave tag from after the command 2 length 330 using load modulating signals. At this time, the data from the command 1 length 322 to the data 1 row 328 are deleted.

FIG. 12A is an example of the structure of send data 500 (response frame) in the case where a response (with error) is made from the slave tag 12-1 to the reader/writer 14. The send data 500 include the SOF 110, the FLAGS 120, error code 510, the CRC 150 and the EOF 160. An error code is set in the error code 510. It is the response information for the send data 400 in FIG. 11.

FIG. 12B is an example of the structure of send data 600 in the case where a response (without error and reply data) is made from the slave tag 12-1 to the reader/writer 14. The send data 600 include the SOF 110, the FLAGS 120, the CRC 150 and the EOF 160. FIG. 11 is the response information for the send data 400.

FIG. 12C is an example of the structure of send data 700 (response frame) in the case where a response (without error and with reply data) is made from the slave tag 12-1 to the reader/writer 14. The send data 700 include the SOF 110, the FLAGS 120, DATA 710, the CRC 150 and the EOF 160. The DATA 710 include the request 1 command code 324, the 1 UID 326 and the data 1 row 328. The data 1 row 328 is set with a fixed length data that are dependent on the request 1 command code 324. For example, the sensor data are set with 2 bytes, the memory read is set with the block read data length. The send data 700 are the response data for the send data 400.

FIG. 13A is an example of the structure of send data 800 in the case where a transmission is made from the master tag 10-1 to the slave tag 12-1. The send data 800 include the SOF 110, the FLAGS 120, the request 1 command code 324, the 1 UID 326, the data 1 row 328, the command length (=0 fixed) 332, the CRC 150 and the EOF 160. The send data 800 to be sent from the master tag 10-1 to the slave tag 12-1 are send data for one slave tag. That is, even if a command for a plurality of slave tags is included in the send data transmitted from the reader/writer 14, the send data are divided in the master tag 10-1 into send data directed to one slave tag. The request 1 command 324, the 1 UID 326 and the data 1 row 328 are data directed to the slave tag 12-1. The data value of the command length (=0 fixed) 332 is 0 and fixed.

FIG. 13B is an example of the structure of send data 900 in the case where a transmission is made from the slave tag 12-2 to the slave tag 12-5. The send data 900 include the SOF 110, the FLAGS 120, request 2 command code 910, 2 UID 912, data 2 row 914, command 3 length 916, FLAGS 918 . . . the command length (=0) 332, the CRC 150 and the EOF 160. The send data 900 are send data that are directed to a plurality of slave tags. The slave tag 12-5 checks if there is a next command (the command 3 length 916 thereof is not 0) in the send data, and if there is any command, deletes the command directed to itself and sets the remainder. The FLAGS 120, the request 2 command code 910, the 2 UID 912 and the data 2 row 914 are data directed to the slave tag 12-1. The command 3 length 916, the FLAGS 918, . . . are data that are directed to the slave tag 12-5. The data value of the command length (=0 fixed) 332 is 0 and fixed.

Thus, use of the inter-tag communication that makes use of the load modulating signals of the tags allows the tags to appear as if they had been added with new functions, i.e. as if they had been integrated through use of the inter-tag communication. This allows the tags to be added with new functions without being provided with a plurality of functions, thereby promising cost-reduction of the tags.

The present invention is not limited to the embodiments described above, but allows various modifications. For example, the invention includes structures that are substantially the same as the structures described in the embodiments (e.g. structures having the same functions, method and results or having the same objective and results). Also, the invention includes structures that are the same as the structures described in the embodiments, unessential parts of which, however, have been replaced. In addition, the invention includes structures that are capable of bringing out the same effects or achieving the same goal as the structures described in the embodiments. The invention also includes structures embracing heretofore known techniques in addition to the structures described in the embodiments. Furthermore, the invention includes contents that embrace the technical matters described in the embodiments, but exclude any of those matters in a restricted manner. Besides, the invention includes the embodiments described above, from which, however, heretofore known techniques are excluded in a restricted manner.

What is claimed is:

1. A contactless communication scheme comprising:
a first and a second RFID tags that are each registered with a unique ID and communicate in a contactless manner by making use of an electromagnetic field of an antenna; and
a reader/writer that reads/writes data in a contactless manner with respect to the first and the second RFID tags, wherein
the first RFID tag generates power from the electromagnetic field produced by the reader/writer and makes use of the power to communicate with the second RFID tag.

2. The contactless communication scheme according to claim 1, wherein the first RFID tag and the second RFID tag make use of a load modulating signal for communicating with each other.

3. A contactless communication system comprising:
a first and a second RFID tags each of which is assigned to a unique ID communicate in a contactless manner by making use of an electromagnetic field of an antenna; and
a reader/writer that reads/writes data in a contactless manner with respect to the first and the second RFID tags,
the first RFID tag generating power from the electromagnetic field produced by the reader/writer and making use of the power to communicate with the second RFID tag, causing the reader/writer to consider that the first RFID tag has been added with a function of the second RFID tag.

4. The contactless communication system according to claim 3, wherein the first RFID tag and the second RFID tag make use of a load modulating signal for communicating with each other.

5. The contactless communication system according to claim 3, wherein the function added to the RFID tag is at least one of a nonvolatile display function, a sensor function and a memory function.
